(19) United States
(12) Patent Application Publication
(10) Pub. No.: US 2025/0242767 A1
(43) Pub. Date: Jul. 31, 2025

(54) Control Unit for Performing at least One Function Based on Vehicle Location

(71) Applicants: Robert Bosch GmbH, Stuttgart (DE); Bosch Global Software Technologies Private Limited, Koramangala (IN)

(72) Inventor: Samrat Golgar Krishnamurthy, Karnataka (IN)

(21) Appl. No.: 19/039,518

(22) Filed: Jan. 28, 2025

(30) Foreign Application Priority Data
Jan. 31, 2024 (IN) 2024 4100 6292

(51) Int. Cl. B60R 16/023; B60L 7/10; B60L 58/12; B60L 58/24; B60R 16/033; F01N 3/20

(52) U.S. Cl. CPC B60R 16/0231; B60L 7/10; B60L 58/12; B60L 58/24; B60R 16/033; F01N 3/208; F01N 2900/10

(57) ABSTRACT

A control unit for performing at least one function based on vehicle location is disclosed. The control unit identifies a location of interest when the vehicle is in an operating condition and determines a distance between the current location of the vehicle and the identified location of interest. The control unit triggers at least one function, when the determined distance is within a predefined distance.

This application claims priority under 35 U.S.C. § 119 to application no. IN 2024 4100 6292, filed on Jan. 31, 2024 in India, the disclosure of which is incorporated herein by reference in its entirety.

This disclosure is related to a control unit for performing at least one function based on vehicle location.

### BACKGROUND

As technology continues to advance, the goal of a fully autonomous vehicle that is capable of navigating on roadways is on the horizon. Autonomous vehicles may need to consider a variety of factors and make appropriate decisions based on those factors to reach an intended destination safely and accurately.

A U.S. Pat. No. 8,635,020 discloses a method for automatically entering favorite locations into a navigation system is provided. The method according to one embodiment includes receiving information regarding a location from an object within a vehicle using a navigation system. An identifier to the information and the information and identifier are stored in the navigation system. The user may retrieve the information from the navigation system using the identifier. The information from the objects may be received in various wireless formats, including RFID, Bluetooth and Wi-Fi.

### BRIEF DESCRIPTION OF THE DRAWING

FIG. 1 illustrates a control unit in a vehicle in accordance with an embodiment of the disclosure.

### DETAILED DESCRIPTION

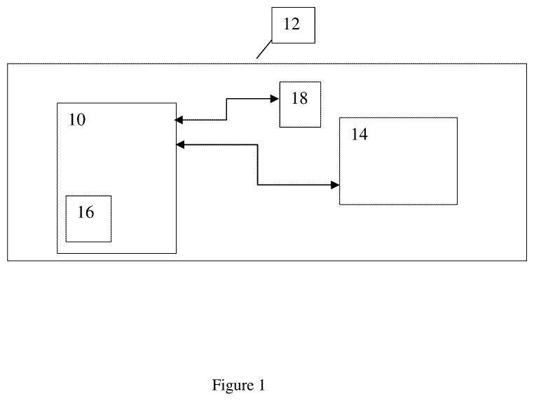

FIG. 1 illustrates a control unit 10 in a vehicle according to one embodiment of the disclosure. The control unit 10 identifies a location of interest when the vehicle 12 is in an operating condition and determines a distance between the current location of the vehicle 12 and the identified location of interest. The control unit 10 triggers at least one function, when the determined distance is within a predefined distance.

Further the construction of the control unit and the components connected to the control unit is explained in detail. The control unit is a logic circuitry and software programs implemented as one or more microprocessors, microcomputers, microcontrollers, digital signal processors, central processing units, state machines, logic circuitries, and/or any component that operates on signals based on operational instructions. Modern day vehicles may contain a plurality of control unit s like the Airbag control unit, Transmission control unit, Glow time control unit, Heating control unit, Vehicle charge communication unit, Engine control unit, Vehicle control unit, Steering control unit and the like. In an exemplary embodiment of the present disclosure, the control unit could be a vehicle control unit.

The control unit 10 comprises a memory to store information related to multiple location of interests and an interface 14 for inputting the location of interest. The location of interest is inputted into the control unit 10 via plurality of methods. Few such methods that are practiced is a manual entry, wherein the user of the vehicle 10 enters the location of interest of his choice and the vehicle 10 is detected in proximity or within the predefined distance range, a certain function is performed. In another way, the location of interest is inputted automatically based on the current/past requirements of the user of the vehicle 10. One such location of interest is a shopping mall, a recreation place, or the like. In this case, the vehicle control unit 10 automatically includes/updates the list of location of interest in the memory 16 of the control unit 10. Yet in another way of inputting the location of the interest, a travel history of the vehicle is considered, and the control unit stores the required locations in the memory 14. The location of interest is chosen from a group of locations comprising a home, a nearby charging station, an office.

The at least one function is chosen from a group of functions comprising a discharging of battery, preparing a battery from thermal charging, an extended regenerative braking, regulating AdBlue dosing. According to one embodiment of the disclosure, the at least one function to be performed in mapped to the identified location of interest in a memory 16 of the control unit 10. Multiple locations of interests are mapped to multiple functions to be performed in the vehicle. One such instance is, discharging battery is mapped to a charging station in the memory 16 of the control unit 10.

According to one embodiment of the disclosure, the at least one function to be performed is based on a type of the vehicle 12. Wherein the type of the vehicle 12 is chosen from the group of vehicles comprising an internal combustion engine vehicle, a hybrid vehicle, an electric vehicle. Optimizations in performing the function in the vehicle 12 is made location specific. For example, if the type of the vehicle 12 is an ICE engine vehicle and if the vehicle 12 is approaching the home or office location, where vehicle 12 will be switched off, it is good for exhaust components to prohibit regeneration. In another instance, if the vehicle 12 is a hybrid vehicle and when the hybrid vehicle is near home location (or any other regular parking location where charging is done), it is optimal to take the battery to lowest temperature to utilize the battery and charge it when parked. Yet in another example, if the type of the vehicle 12 is an electric vehicle and when the electric vehicle is nearing to a charging location like home or a regular charging station, it is good to prepare the battery thermally to enable efficient and fast charging.

According to one embodiment of the disclosure, the predefined distance, or the distance between the current location of the vehicle 12 and the location of the interest is divided into multiple stages. I.e., depending on the distance determined, the functions to be performed in the vehicle 12 is made to change. The control unit 10 performs at least one function based on a difference in distance between the current location of the vehicle 12 and said location of interest. In one exemplary embodiment, multiple functions are performed at once or simultaneously, when the vehicle 12 is in proximity of the location of interest. When the distance is little far away from the location of the interest and is in within the predefined distance range, then the vehicle control unit 10 will start performing the functions in the vehicle 12 one after the other.

A method of working of the control unit 10 performing the functions in the vehicle 12 based on the location of interest is explained in detail. The location of interest is specific or as per the requirement of the user of the vehicle 12. The location of interest is identified in the vehicle control unit 10 using GPS coordinates. The information is taken from a navigation unit, or a GPS sensor in the vehicles like a public bus/school bus/taxi's or it can be through a smart communication device (like a mobile phone, a personal digital assistant) that is linked/in communication with the vehicle 12. When the location of interest is identified, then the corresponding action is triggered like long parking, charging, extended regenerative braking and the like.

The control unit 10 stores the location details in memory 16. According to one embodiment of the disclosure, the location details can be stored in a cloud repository and is received upon sending/transmitting a signal from the control unit. Further to this, the control unit 10 stores the regular locations/repeated locations. The control unit 10 comprises a counter (not shown) for counting an occurrence every time when the vehicle 12 reaches that regular location.

When vehicle 12 is in operational mode, the control unit 10 continuously monitors the current location with respect to these stored regular locations. The GPS distance is used to determine the proximity to the stored locations. If the vehicle is approaching one of the stored location/locations of interest (distance reducing) and the current distance is less than pre-determined distance (e.g.: 1 km), then the control unit 10 triggers to perform certain corresponding functions in control unit 10 to prepare the vehicle for optimization needed. One of the methods that is used to determine the distance between the current location of vehicle 12 and the location of interest is achieved using haversine technique. However, it is not restricted to above disclosed technique, but can be any other technique that is used to determine the distance between two GPS coordinates/two locations.

The control unit 10 triggers at least one function, when vehicle 12 is closer to the stored “regular location”/location of interest. When the proximity trigger is activated by the control unit 10, the vehicle needs to be prepared for the optimization function associated with location. For example, when the regular charging location/location of interest is approaching AND the battery level is low, it is most likely that the vehicle needs a charge. To make the charging most efficient and fast, it is necessary to maintain the battery temperature in a window. Once the proximity trigger is received this thermal preparation of battery 18 is activated. In another example, in case of normal ICE engine vehicle, diesel particle regeneration can be stopped/inhibited or AdBlue dosing can be stopped/reduced. The above disclosed functions are performed automatically.

The control unit 10 calculates and stores the benefits of these predictive function and informs the user of the vehicle 12. This provides the effectiveness and the advantages of performing the functions in advance to the user of the vehicle 12.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A control unit for performing at least one function based on a vehicle location, said control unit being configured to:
identify a location of interest when said vehicle is in an operating condition;
determine a distance between a current location of said vehicle and said identified location of interest; and
trigger said at least one function, when said determined distance is within a predefined distance.

2. The control unit as claimed in claim 1, wherein said location of interest is input into said control unit via an interface in any of the following manners comprising: a manual entry, an automatic identification of said location of interest, and a past history.

3. The control unit as claimed in claim 1, wherein said location of interest is chosen from a group of locations comprising: a home, a nearby charging station, and an office.

4. The control unit as claimed in claim 1, wherein said at least one function is chosen from a group of functions comprising: a discharging of battery, a preparing battery from thermal charging, an extended regenerative braking, and a regulating AdBlue dosing.

5. The control unit as claimed in claim 1, wherein said at least one function to be performed is mapped to said identified location of interest in a memory of said control unit.

6. The control unit as claimed in claim 1, wherein said at least one function to be performed is based on a type of said vehicle.

7. The control unit as claimed in claim 1, wherein said control unit is configured to perform at least one function based on a difference in distance between said current location of said vehicle and said location of interest.

8. The control unit as claimed in claim 7, wherein multiple said functions are performed, when said vehicle is in proximity of said location of interest.
